(19) United States
(12) Patent Application Publication
(10) Pub. No.: US 2016/0247016 A1
(43) Pub. Date: Aug. 25, 2016

(54) METHOD FOR RECOGNIZING GESTURES OF A HUMAN BODY

(71) Applicant: DRÄGERWERK AG & CO. KGAA, Lübeck (DE)

(72) Inventors: Kristian EHLERS, Lübeck (DE); Jan FROST, Lübeck (DE)

(73) Assignee: Dragerwerk AG & Co. KGaA, Lubeck (DE)

(21) Appl. No.: 15/030,153

(22) PCT Filed: Oct. 17, 2014
(86) PCT No.: PCT/EP2014/002811

§ 371 Date: Apr. 18, 2016

(30) Foreign Application Priority Data
Oct. 19, 2013 (DE) 10 2013 017 425.2

(51) Int. Cl. G06K 9/00; G06F 3/01; G06T 7/00

(52) U.S. Cl. CPC G06K 9/00355; G06T 7/0065; G06F 3/017; G06T 2207/10028; G06T 2207/30196

(57) ABSTRACT

A method for recognizing gestures of a human body (10) with a depth camera device (110), having the steps:
generating a point cloud (20) by the depth camera device at a first time (t1) as an initial image (IB);
analyzing the initial image (IB) to recognize limbs (12) of the body;
setting at least one joint point (14) with a rotational degree of freedom defined by an angle of rotation (α) in reference to a recognized limb;
generating a point cloud at a second time (t2) after the first time as a next image (FB);
analyzing the next image for a recognized limb and the set joint point from the initial image;
determining the angle of rotation of the joint point in the next image;
comparing the angle of rotation with a preset value (RV); and
recognizing a gesture upon correlation of the angle of rotation with the preset value.

### CROSS REFERENCE TO RELATED APPLICATIONS

This application is a United States National Phase Application of International Application PCT/EP2014/002811 filed Oct. 17, 2014 and claims the benefit of priority under 35 U.S.C. §119 of German Patent Application 10 2013 017 425.2 filed Oct. 19, 2013, the entire contents of which are incorporated herein by reference.

### FIELD OF THE INVENTION

The present invention pertains to a method for recognizing gestures of a human body as well as to a recognition device for recognizing gestures of a human body.

### BACKGROUND OF THE INVENTION

It is known that gestures of human bodies can be recognized by means of depth camera devices. For example, systems are thus available commercially which are capable of determining the positions of individual body parts or individual limbs relative to one another. Gestures and hence a gesture control can be derived from this relative position, e.g., of the forearm in relation to the upper arm. Prior-art methods are used, for example, to carry out the control of computer games or television sets. A point cloud, from which the current position of the particular body parts and hence the correlation of the body parts with one another can be calculated by means of calculation algorithms, is usually generated here by the depth camera. The entire point cloud must be processed according to this analysis method for all times.

It is disadvantageous in prior-art methods that a relatively high amount of calculations is necessary for each time of the method. Thus, a complete point cloud must be recognized anew and analyzed anew after each motion during a motion of the body. This requires an immense amount of calculations, which is not usually possible, especially when distinguishing small body parts down to individual limbs. Prior-art methods are correspondingly limited to the recognition of relatively coarse gestures, i.e., for example, the motion of an arm upward or downward or a waving motion of the forearm. Fine motions, e.g., different gestures of a hand, especially gestures produced by different finger positions, can only be handled by prior-art methods with a disproportionally large amount of calculations. This drives up the cost of carrying out such methods to such a level that is economically unacceptable. In addition, depth cameras with very fine resolution are necessary in such a case in order to image the individual limbs in the point cloud at the necessary speed in such a way that they be distinguishable from one another. This likewise leads to a great increase in the costs, which are necessary for carrying out a corresponding method.

### SUMMARY OF THE INVENTION

An object of the present invention is to at least partially eliminate the above-described drawbacks. An object of the present invention is, in particular, to also make it possible to recognize fine gestures, especially to recognize gestures of individual phalanges of fingers in a cost-effective and simple manner.

The above object is accomplished by a method according to the invention and a recognition device according to the invention. Features and details that are described in connection with the method according to the present invention also apply, of course, in connection with the recognition device according to the present invention and vice versa, so that reference is and can always mutually be made to the individual aspects of the present invention concerning the disclosure.

According to the invention, a method is provided to recognize gestures of a human body by means of a depth camera device, having the following steps:
a) generation of a point cloud by the depth camera device at a first time as an initial image,
b) analysis of the initial image to recognize limbs of the body,
c) setting of at least one joint point with a rotational degree of freedom defined by a rotation angle in relation to at least one limb,
d) generation of a point cloud by the depth camera device at a second time after the first time as a next image,
e) analysis of the next image for the at least one recognized limb and the at least one set joint point from the initial image,
determination of the angle of rotation of the at least one joint point in the next image,
g) comparison of the determined angle of rotation with an angle of rotation preset value, and
h) recognition of a gesture in case of correlation of the determined angle of rotation with an angle of rotation preset value.

The method according to the present invention is also used to recognize fine gestures, especially of individual limbs, such as the fingers of a hand of a human body. However, the method may also be used, in principle, for the human body as a whole, i.e., for any limb. Thus, limbs can be defined especially as individual, movable bone elements of the human body. These may be formed, e.g., by the lower leg, the thigh, the upper arm or the forearm. Finer joints, especially the individual phalanges of each finger of a hand, may also represent limbs of the human body in the sense of the present invention.

No complete analysis of the point cloud is performed at each time in the sense of the present invention. A comparison of the point cloud at two different times may rather make possible a reduction to a model of the particular limb and the corresponding joint point. Thus, it is no longer necessary to perform a complicated comparison of images to recognize gestures. The recognition of the gesture can rather be reduced to a direct or indirect comparison of angles of rotation with the angle of rotation preset value. No complete agreement but only a sufficient, especially predefined proximity needs to be present in case of an indirect comparison.

A method starts according to the present invention with an initialization. The depth camera device is preferably equipped with at least one depth camera and can generate a three-dimensional point cloud in this way. At the first time, which may also be called the initialization time, this point cloud is consequently formed as an initial image. The analysis of this initial image is performed in respect to the recognition of limbs of the body. The entire point cloud or only partial areas of this point cloud may be analyzed in detail in the process. In particular, the analysis is performed only in the area of the body parts that comprises the limbs necessary for the gestures. If, for example, a human body is recognized and a gesture of the fingers is searched for, the detailed analysis of the initial image is performed in the areas of the hand only in order to perform the recognition of the individual phalanges of the fingers of the body.

The joint point is set in relation to the particular recognized limb. For example, the individual fingers of the hand of a human body are thus defined by individual limbs in the form of phalanges of fingers. Human joints, which have one or more rotational degrees of freedom, are provided between the individual limbs. The connection between the individual limbs is reflected by the model underlying the present invention by joint points with exactly one defined degree of freedom. If the real joint between two limbs on the human body is a formation with two or more rotational degrees of freedom, it is, of course, also possible to set two or more joint points with a defined degree of freedom each. It is thus also possible to image according to the present invention complex joints of a body, which have two or more rotational degrees of freedom.

An initial angle of rotation, which reflects the positioning of the two adjacent limbs in relation to one another in a defined manner, is obtained by setting the joint point. This angle of rotation consequently represents the current positioning of the limbs in relation to one another.

The angle of rotation of each joint point is determined in the respective coordinate system, belonging to the particular joint point. Each joint point, which is set in the method according to the present invention, has a coordinate system of its own. Due to individual limbs being interlinked, as this is the case, e.g., in individual phalanges of the fingers of the hand of the human body, a translatory and/or rotatory motion of the individual coordinate systems thus also occurs during complex motions of the individual limbs relative to one another. To keep the subsequent analysis steps as simple as possible, the angle of rotation is, however, always set in reference to the particular, e.g., translatory coordinate system of the corresponding joint point, which is moving along. A defined position of all limbs relative to one another is thus obtained due to the correlation of the plurality of angles of rotation in case of a plurality of joint points.

As can be seen in the above paragraph, a plurality of joint points are preferably used and set. A plurality of angles of rotation are thus also obtained for this plurality of joint points. These can be preset and stored for greater clarity, e.g., in a single-column and multirow vector. This single-column and multirow vector thus reflects the relative position of the individual limbs in relation to one another in a defined and above all unambiguous manner.

It should be noted in this connection that it is also unnecessary to set a joint point for each recognized limb. For example, a recognition of all limbs of a body can thus take place, and the joint points are set for the further method steps for the two hands only or for one hand only. In other words, a selection is made from among all recognized limbs when setting the joint points. This selection may comprise a subset or also all recognized limbs. However, at least a single joint point is set for at least one recognized limb.

After an initialization of the current situation of the human body could be performed by the steps a) through c), the gesture recognition can now be performed. A point cloud is again generated by means of the depth camera device as a next image at a second time after the first time. The analysis is performed now for the limbs already recognized during the initialization and with reference to the set joint points from the initial image. The determination of the angle of rotation of the at least one joint point is subsequently performed in the next image. In other words, a new single-column and multirow vector with a plurality of angles of rotation is obtained now for a plurality of j oint points. The change of the angles of rotation within this vector between the initial image and the next image corresponds to the change of the limbs and, derived from this, of the gesture in the real situation on the human body.

A comparison of the determined angle of rotation in the next image can subsequently be performed with an angle of rotation preset value. The angle of rotation preset value is likewise, for example, in the form of a single-column, multirow vector. A row-by-row comparison can thus be performed to determine whether there is an agreement or essentially an agreement between the determined angles of rotation and this angle of rotation preset value or whether there is a sufficient, especially predefined proximity to these determined angles of rotation and this angle of rotation preset value. If so, the real motion position of the respective limbs of the human body corresponds to the gesture correlated with this angle of rotation preset value.

The angle of rotation preset value may, of course, have both specific and unambiguous values as well as value ranges. Depending on how accurately and definably the recognition of the particular gesture shall be performed, the angle of rotation preset value can correspondingly be made especially narrow or broad as a range of angles of rotation.

As is clear from the above explanations of the recognition of gestures, a plurality of different angle of rotation preset values are stored, in particular, as gesture-specific values. The steps of comparing and recognizing the angle of rotation or the gesture are thus performed, e.g., sequentially or simultaneously for all gesture-specific stored data of the angle of rotation preset values. Thus, the comparison is performed until a sufficient correlation is recognized in the form of an agreement or essentially an agreement between the determined angle of rotation and the angle of rotation preset value. The determined angles of rotation can thus be associated with the gesture specific of this angle of rotation preset value.

The above explanations also show that a comparison of images as a whole is no longer necessary now for recognizing the gesture. The task of recognition is rather reduced, as a whole, to the comparison of angles of rotation with an angle of rotation preset value, which can be performed in an especially cost-effective and simple manner in terms of the necessary amount of calculations. The single-row comparison of a multirow, single-column vector with a corresponding angle of rotation preset value is a very simple calculation operation, which requires neither an expensive computer or an especially large amount of time.

A further advantage of the method according to the present invention is achieved by the actual human body having been able to be reduced from the point cloud to a corresponding model of the human body with respect to joint points and limbs. Thus, only the set, defined joint points rather than the entire point cloud must be examined for the comparison between the initial image and the next image. The steps of analyzing the next image with respect to the corresponding initial image are thus also reduced in terms of the necessary amount of calculations.

A method according to the present invention is used especially in medical engineering, e.g., for the gesture control of medical devices. It is advantageous especially in that field, because a plurality of commands can now be controlled by a great variety of finger gestures. At the same time, the sterility of the particular user, especially of the user's hand, is not compromised by the gesture control. The advantages explained and described can correspondingly be achieved especially advantageously in the field of medicine in connection with medical devices for controlling same.

Other fields of application are, of course, also conceivable for a method according to the present invention. For example, the method according to the present invention can be used for a conventional gesture recognition in controlling a machine or even a vehicle. Operating actions in a vehicle may also be performed by a method according to the present invention by means of gesture control. A gesture recognition method according to the present invention may likewise be used in case of the control of actions of technical devices, such as television sets, computers, mobile telephones or tablet PCs. Furthermore, highly accurate position recognition of the individual limbs can make it possible to use this method in the field of medicine in the area of teleoperation. A basic interaction between man and machine or man and robot is also a possible intended use within the framework of the present invention.

A method according to the present invention can be perfected such that the steps d) through h) are carried out repeatedly, the next image from the preceding pass being used as the initial image for the next pass. A tracking or a follow-up method is thus made, so to speak, possible, which permits a monitoring to be performed essentially continuously stepwise with respect to a change in gestures. This becomes possible especially due to the fact that the necessary amount of calculations for carrying out each step of recognizing a gesture has been markedly reduced in the manner according to the present invention. Consequently, contrary to prior-art methods, no individual determination is performed any more for each time, but the joint model of the human body or part of the human body, once determined initially, is used in a repeated manner for any desired length of time. Continuous gesture monitoring will thus become possible, so that it is no longer necessary to intentionally activate a gesture control for the actual control operation.

It is likewise advantageous if the angle of rotation preset value comprises a preset range of angles of rotation in a method according to the present invention, and a comparison is performed to check whether the determined angle of rotation is within the range of angle of rotations. As was mentioned already, the angle of rotation preset value may be a single-column, multirow vector. A specific and unambiguous angle of rotation can be used as an angle of rotation preset value for every individual row. It is, however, preferable if a range of angles of rotation, which is specific for a gesture, e.g., between 10° and 25°, is stated here in each cell. The width of the particular range of angles of rotation is preferably made adjustable, especially likewise in a gesture-specific manner. It is thus possible to achieve a clear and defined distinction of very similar finger gestures from one another by means of especially narrow ranges of angles of rotation. If distinction is to be made only among a small number of gestures from one another in a method according to the present invention, an especially broad range of angles of rotation may also be able to be used for a greater freedom in the actual recognition. The degree of error recognition or the distinction of similar gestures can correspondingly be described especially preferably by means of the range of angles of rotation and the breadth of that range. It can also be clearly seen here that for different gestures, the specificity the specification is performed by the sum of all angle of rotation preset values in such a multirow vector. Depending on how broad the range of angles of rotation is made, even gestures made poorly can be recognized. Further, it is possible here to train gestures. So-called training sets can be recorded for this, and these will subsequently be classified. The angle of rotation preset values can be defined quasi implicitly on the basis of these training data.

It is likewise advantageous if the steps a) and b) are carried out in a method according to the present invention with a defined gesture of the limb in question, especially at least twice one after another with different gestures. This represents quasi a defined initialization of this method. One possibility is to provide a defined gesture for the initialization step with the fingers spread as a sum of the limbs to be recognized. A defined sequence of gestures, e.g., the spreading of all fingers and the closing to make a first, as two different gestures made one after another, may also provide a double initialization step. This is, however, only a preferred embodiment. The method according to the present invention also functions without the use of defined gestures for the initialization. Yet, these defined gestures for the initialization can improve the initially setting of the joint points in terms of accuracy. The possibility of initialization being described here may be used both at the start of a method according to the present invention and in the course of the process. The steps of the second loop c) through h) follow the execution of the steps of the first loop a) and b). The two loops may be repeated as often as desired. If, for example, two defined gestures are provided for the initialization, the first loop will be run twice before the method enters the second loop. Since the second loop describes the recognition of the gesture and hence the preferably continuous monitoring, this second loop is preferably repeated without a fixed end value. A maximum number of repetitions of the second loop may also trigger an automatic calibration by the first loop, for example, after every 1000 runs through the second loop.

It is advantageous, moreover, if, in a method according to the present invention, this method is carried out for at least two joint points, especially for a plurality of joint points, the joint points together forming a model of the limb. As was already explained, complex parts of a body, e.g., the hand with the phalanges of the fingers and hence a plurality of limbs connected to one another via joints can be made into the basis of the method according to the present invention in a limb model in an especially simple manner and with a small amount of calculations. Thus, it becomes possible to use, for example, robotics rules in a reverse form. For example, known transformation rules between the individual translatorily and/or rotatorily movable coordinate systems of the joint points can be provided in such a case in order to correspondingly recognize a reverse determination of the gesture that was actually taking place or of the motion that was actually taking place.

It is advantageous, furthermore, if all the points of the point cloud belonging to the at least one joint point are recognized during the analysis of the next image in a method according to the present invention and the center of gravity (centroid) of these points is set as the new joint point. The actual positioning of the joint point thus depends, among other things, on the resolution of the depth camera device. It is not possible in case of relatively large depth camera devices to associate an individual specific point with the joint point in question. All the points that are recognized as belonging to the particular joint point are thus defined for this and the center of gravity of these points is set as a new joint point. This is helpful for making it possible to position the new joint point explicitly and as accurately as possible even in case of more cost-effective depth cameras with a lower resolution.

It is advantageous if, in a method according to the present invention, this method is carried out for the limbs of a human hand. This is possible, in general, with an acceptable amount of calculations only by means of a method according to the present invention. The human hand has a very large number of gestures due to the plurality of limbs and the plurality of the finger joints actually present. Thus, the human hand forms an especially simple and above all highly variably usable medium for recognizing a great variety of gestures.

A method according to the present invention according to the above paragraph can be perfected by an equal number of joint points and limbs forming a hand model for all fingers of the hand. This hand model is consequently the limb model in this case, as it was already explained. Due to all fingers of the hand, including the thumb, being formed in the same way, i.e., with an equal number of joint points and limbs, the cost needed for the calculation is reduced further when carrying out a method according to the present invention. The thumb, in particular, occupies a special position on the hand from a medical point of view. The proximal joint of the thumb is not a finger joint proper in the medical sense, but it does represent a mobility of the thumb. One or more joint points may likewise be used here to image this mobility in the hand model according to the present invention. If, however, the gesture variants of this mobility of the thumb are not needed, the corresponding joint point can be set for the thumb without rotational degree of freedom and hence as a blind joint point. The agreement with the number of joint points is thus preserved for all fingers. However, the amount of calculations needed decreases at least for the gesture recognition on the thumb. In other words, the relative motion and/or the change in position is set at zero for this joint point.

In addition to the reduction of the necessary amount of calculations, another advantage is the fact that the individual hand models can be mirrored. It thus becomes possible to apply software, without adapting it, to both hands and to both hand alignments. The possible number of gestures can thus even be doubled or multiplied, because a correlation of gestures of both hands can be recognized. It is preferred if the two hands are distinguished from each other, i.e., the left hand and the right hand can each be recognized as such. It should be noted in this connection that it is decisive for the hand model whether the hand in question is perceived in the view to the back of the hand or in the view to the palmar surface. For example, initial defined gestures, which are described in this application, may be used for this distinction. It is also possible to infer the alignment of the hand from the course of the recognition and the direction of the joint motions. The real mobility of the joints can be taken into account here. In other words, the alignment of the recognized hand as “left” or “right” hand and as “palmar surface view” or “back of hand view” can be additionally determined based on a sequence of runs of a method according to the present invention.

It may also be advantageous to set three joint points for the back of the hand, the wrist and/or the arm stump and the palmar surface in a method according to the present invention. Since, as was already explained, the location of the respective joint point can be defined, e.g., by a plurality of points of the point cloud based on the center of gravity or centroid of these points, incorrect positioning would possibly take place in case of certain hand positions and with a single joint point for the back of the hand. In other words, the corresponding center of gravity would be inferred for the back of the hand from fewer and fewer and/or close closely adjacent points of the point cloud. In other words, the points of the point cloud would contrast around the center of gravity of the back of the hand and yield a poorer geometric mean for this center of gravity. The position of the joint point set with it would also become more inaccurate, so that the real position would be reflected only insufficiently or possibly erroneously in case of certain joint positions. To make possible an especially advantageous and good recognition of the particular gesture even in such complex gesture situations, three joint points are set now for the back of the hand. A relatively good result can nevertheless be obtained in this manner for the positioning of the back of the hand especially in case of depth cameras of the depth camera device which have a relatively low resolution and are thus more cost-effective. It is especially advantageous if two joint points are drawn from the back of the hand into the arm stump.

It is likewise advantageous if at least one additional joint point is set on the side of the hand located opposite the thumb in the hand model in a method according to the present invention. The same advantages are thus achieved as in the above paragraph. In particular, the joint point is set mirror symmetrically or essentially mirror symmetrically to the corresponding closet joint point of the thumb. In other words, the entire back of the hand is defined by the three joint points on the back of the hand and/or by the additional joint point according to this embodiment, so that an undesired incorrect positioning or contraction of the back of the hand to an individual joint point can be avoided. It is, of course, also possible for even more points, especially intermediate points with a finer network to define the back of the hand in order to achieve these advantages even better.

It is likewise advantageous if the length of the limb between the two joint points has a preset value when determining at least two joint points in a method according to the present invention. The individual limbs are consequently reflected in the diagram of the hand model or of the limb model by their length, quasi as a frame with rigid joints. The individual joint points are connected to one another by the length of the respective rigid joint. If this length is predefined, the subsequent analysis will require an even smaller amount of calculations. In particular, the length may also be made adjustable, so that, e.g., coarse set values of great, small and medium lengths can be preset for the particular limb. Adaptation or self-learning design over the course of the method is, of course, also possible for the length of the particular limbs. The amount of calculations needed is reduced in this manner especially for the initialization step for the first image as the initial image.

It is advantageous, moreover, if at least two joint points are set at a common location in a method according to the present invention in order to reproduce a human joint with at least two rotational degrees of freedom. Especially the joint between the metacarpal bone and the proximal finger bone is a joint with two rotational degrees of freedom in the human body. To transfer such a complex joint into the simple method according to the present invention, two joint points can correspondingly be placed at the common location. This makes it possible to also use the method according to the present invention in case of a real, more complex human joint. The above-described robotics rules, which can be used, e.g., in the form of the Denavit-Hartenberg rules, can continue to be used in this case.

It is advantageous, moreover, if the angles of rotation of at least two joint points are stored in a single-column vector and are compared row by row with the angle of rotation preset value in the form of a single-column vector in a method according to the present invention. This embodiment was already explained in a number of publications. It is clearly seen here that an individual comparison of rows can provide gesture recognition. The angle of rotation preset value vector is gesture-specific. An angle of rotation preset value and hence a gesture-specific angle of rotation preset value vector are correspondingly provided for each desired gesture that is to be recognized. The corresponding comparison is performed simultaneously or sequentially with the single-column vector of all recognized angles of rotation and with all single-column vectors of the angle of rotation preset values.

A further advantage can be achieved if the angle of rotation of the initial image is taken over for the next image in a method according to the present invention if it is impossible to recognize a limb and/or a joint point in a next image. The method can thus continue to be carried out in the same manner and with only minor errors in case of limbs partially hidden for the depth camera device. This is another advantage, which clearly shows the great difference from prior-art methods. While hidden limbs cannot be recognized any more in prior-art methods and are correspondingly also no longer available for a gesture recognition, a transfer of an initial image to the next image in the manner according to the present invention can make possible a further recognition by the method according to the present invention here. A compensation is possible, e.g., by correspondingly increasing the width of angle of rotation ranges in the angle of rotation preset value.

The present invention also pertains to a recognition device for recognizing gestures of a human body, having a depth camera device and a control unit. The recognition device according to the present invention is characterized in that the control unit is configured to carry out a method according to the present invention. A recognition device according to the present invention correspondingly offers the same advantages as those explained in detail in reference to a method according to the present invention.

Further advantages, features and details of the present invention appear from the following description, in which exemplary embodiments of the present invention are described in detail with reference to the drawings. The features mentioned in the claims and in the description may be essential for the present invention individually or in any desired combination.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a first view of a point cloud;

FIG. 2 is a view showing a recognized hand;

FIG. 3 is a view showing the hand from FIG. 2 with a limb model arranged therein;

FIG. 4 is a view showing the limb model of the hand alone;

FIG. 5 is a view showing three limbs in a first gesture position;

FIG. 6 is a view showing the limbs from FIG. 5 in a second gesture position;

FIG. 7 is a view showing various embodiments of a method according to the present invention over time;

FIG. 8 is a view showing a possibility of comparing two vectors for the angle of rotation; and

FIG. 9 is a view showing an embodiment of a recognition device according to the present invention.

### DESCRIPTION OF THE PREFERRED EMBODIMENTS

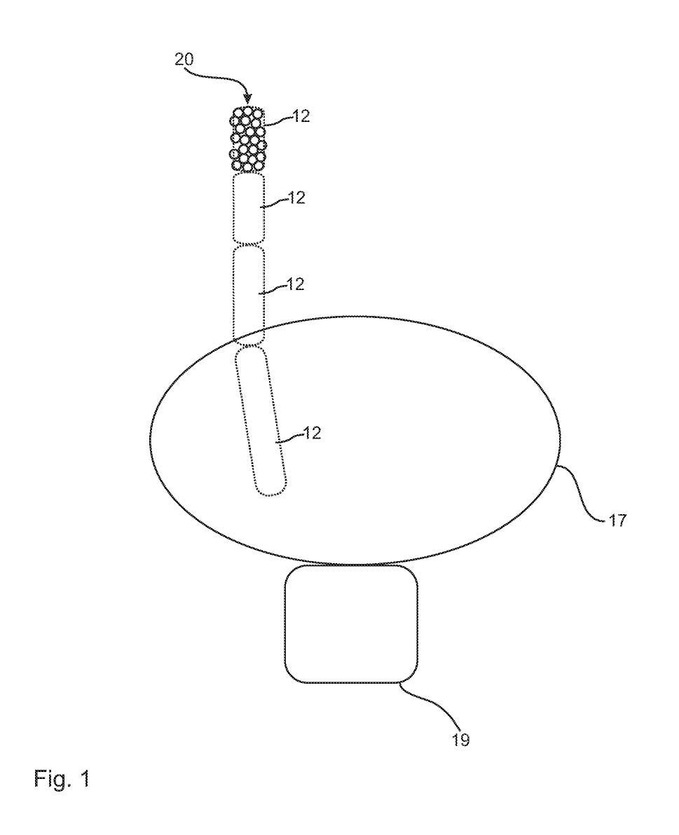

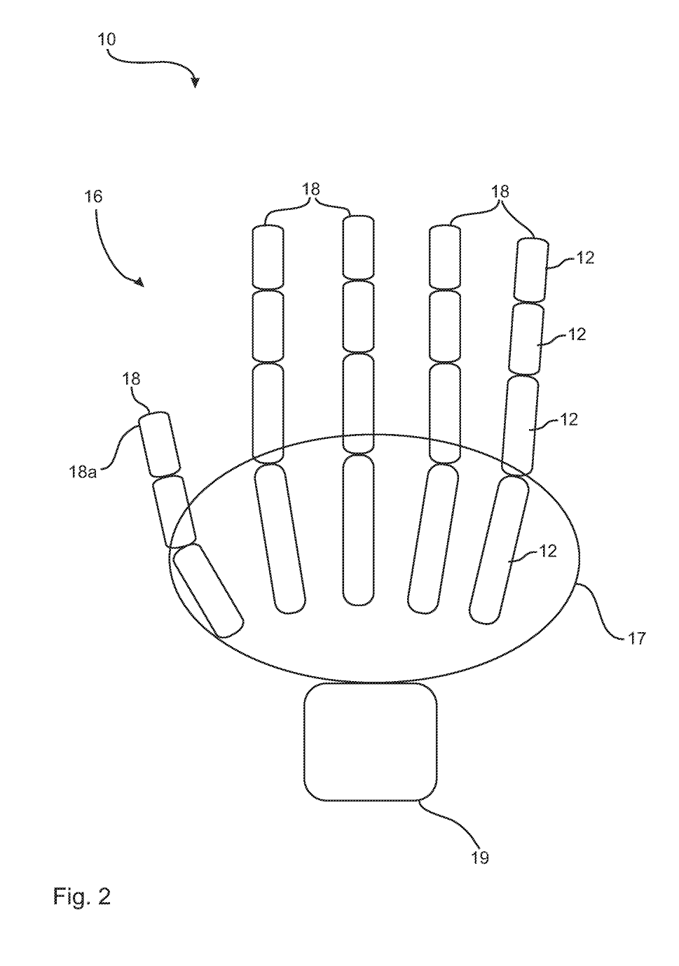

The transmission of information from a recognition device 100 into a limb model 30 is shown generally on the basis of FIGS. 1 through 4. Thus, the entire procedure starts with the recording of a human body 10, here the hand 16, by a depth camera device 110, and it leads to a point cloud 20. The point cloud 20 is shown in FIG. 1 only for the outermost distal finger joint as a limb 12 for clarity's sake. The recognition of all limbs 12 and preferably also of the corresponding back of the hand 17 from the point cloud 20 takes place in the same manner. The result is a recognition in the point cloud 20, as it is shown in FIG. 2. Thus, the entire hand 16 with all fingers 18 including the thumb 18a is located there. These have the respective finger phalanges as limbs 12.

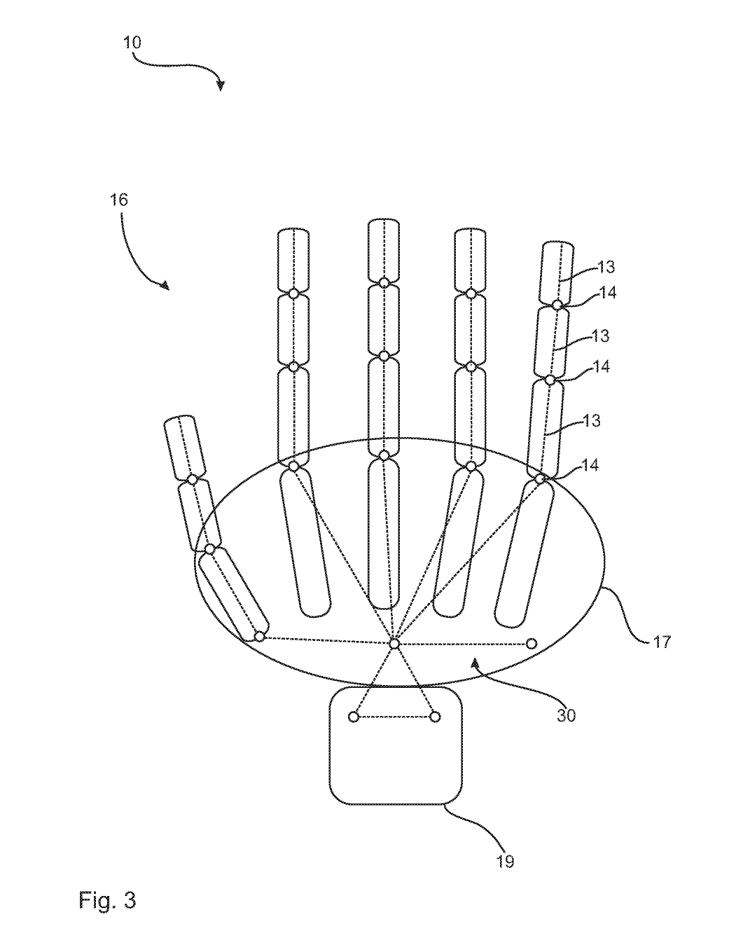

The individual joint points 14 can then be set for a method according to the present invention. These correlate with the respective actual joint between two limbs 12. The distance between two adjacent joint points 14 is preferably preset as the length 13 of the respective limb 12 and is limb-specific. As can also be seen in FIG. 3, an equal number of joint points was used for all fingers 18. Moreover, another joint point 14 was set on the right outside as an opposite joint point to the thumb 18a on the opposite side thereof in the back of the hand 17 of the limb model 30. In addition, three joint points 14 form a triangle in the back of the hand 17 and in the arm stump 19, so that a contraction of the back of the hand 17 during different and above all complex gestures of the hand 16 can ultimately be avoided.

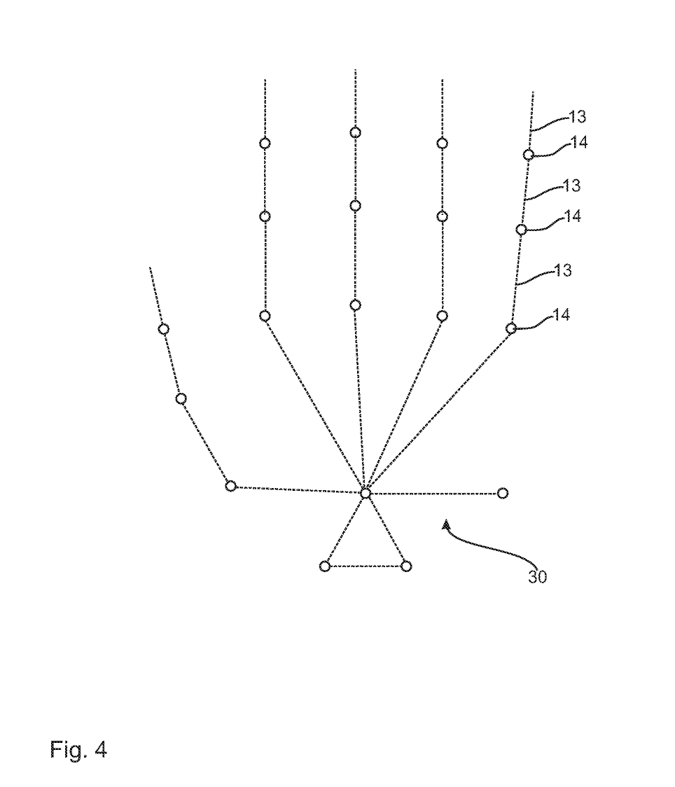

FIG. 4 shows the reduction of the hand 16 of the human body 10 to the actual limb model 30, which can now be used as the basis for the gesture recognition. It is sufficient for the subsequent recognition steps if the corresponding repositioning of the respective joint point 14 is performed from the point cloud 20. Complete recognition of the entire hand 16, as it takes place between FIG. 1 and FIG. 2, does not have to be performed any longer.

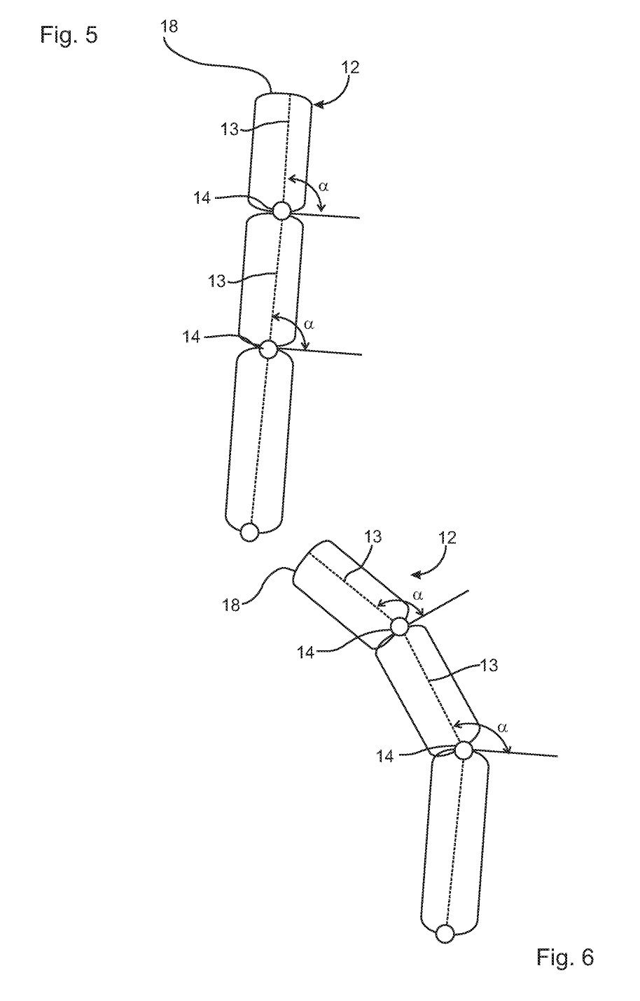

FIGS. 5 and 6 schematically show how the gesture recognition can take place. Thus, a coordinate system of its own is defined for each joint point 14, so that a corresponding angle of rotation α can be recognized for each joint point 14 specifically for this limb 12. If a motion is taking place, e.g., due to bending of the finger, as it happens from FIG. 5 to FIG. 6, the individual angles of rotation α will also change correspondingly. These angles of rotation α can be stored, e.g., in a single-column, multirow vector, as is shown especially in FIG. 8. FIG. 8 also shows a possible comparison with an angle of rotation preset value RV, which is likewise in the form of a vector with angle of rotation preset value ranges in this case. There is an agreement between the two vectors in this embodiment, so that the gesture can be recognized as being present. The angle of rotation preset value RV is correspondingly gesture-specific.

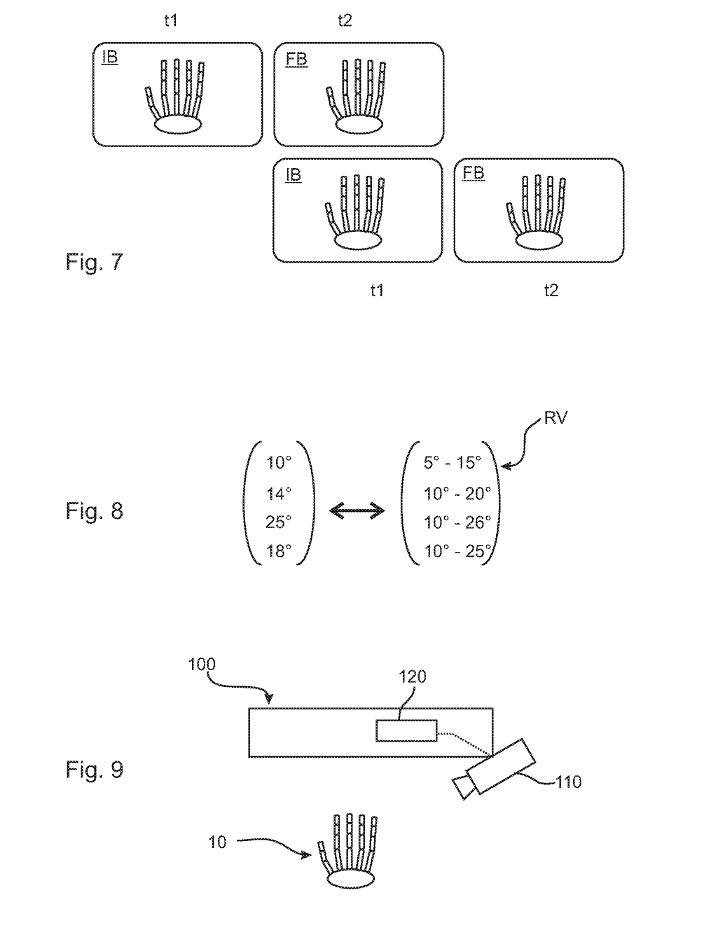

It can be seen in FIG. 7 that the initialization, i.e., the execution, takes place, as it was described from FIG. 1 to FIG. 2, at the start of the method at the first time t1. A comparison with the initial image IB can then take place at a second time t2 in next image FB. For the subsequent steps, the next image FB from the first pass is set as the initial image IB of the second pass and the method can be correspondingly expanded as desired.

FIG. 9 schematically shows a recognition device 100 according to the present invention. This is equipped with a depth camera device 110 having at least one depth camera. This depth camera device 110 is connected to a control unit 120, which is configured to execute the method according to the present invention, in a signal-communicating manner. The human body 10, in this case the hand 16, is located in the range of recognition of the depth camera device 110.

The above explanation of the embodiment describes the present invention exclusively within the framework of examples. Individual features of the embodiments may be freely combined with one another, if technically meaningful, without going beyond the scope of the present invention. While specific embodiments of the invention have been shown and described in detail to illustrate the application of the principles of the invention, it will be understood that the invention may be embodied otherwise without departing from such principles.

1. A method for recognizing gestures of a human body by means of a depth camera device, the method comprising the steps of:
a) generating a point cloud by the depth camera device at a first time as an initial image,
b) analyzing the initial image to recognize limbs of the body;
c) setting at least one joint point with a rotational degree of freedom defined by an angle of rotation in reference to at least one recognized limb;
d) generating a point cloud by the depth camera device at a second time after the first time as a next image;
e) analyzing the next image with respect to the at least one recognized limb and the at least one joint point set from the initial image;
f) determining the angle of rotation of the at least one joint point in the next image;
g) comparing the determined angle of rotation with an angle of rotation preset value;
h) recognizing a gesture in case of correlation of the determined angle of rotation with the angle of rotation preset value.

2. A method in accordance with claim 1, wherein the steps d) through h) are carried out repeatedly, the next image of a preceding step d) being set as the initial image.

3. A method in accordance with claim 1, wherein the angle of rotation preset value comprises a preset angle of rotation range, and a comparison is made to check whether the determined angle of rotation is within the angle of rotation range.

4. A method in accordance with claim 1, wherein the steps a) and b) are carried out with a defined gesture of the limb, at least twice one after another with different gestures.

5. A method in accordance with claim 1, wherein the steps a)-h) are carried out for a plurality of joint points, the joint points together forming a limb model.

6. A method in accordance with claim 1, wherein all the points of the point cloud belonging to the at least one joint point are recognized during the analysis of the next image and a centroid of these points is set as a new joint point.

7. A method in accordance with claim 1, wherein the steps a)-h) are carried out for the limbs of a human hand.

8. A method in accordance with claim 7, wherein the same number of joint points and limbs forms a hand model as a limb model for all fingers of the hand.

9. A method in accordance with claim 7, wherein three joint points are set for the back of the hand, the wrist or the arm stump or are set for any combination of the back of the hand, the wrist and the arm stump.

10. A method in accordance with claim 8, wherein at least one additional joint point is set on the side of the hand located opposite the thumb in the hand model.

11. A method in accordance with claim 1, wherein the length of the limb between the two joint points has a preset value when determining at least two joint points.

12. A method in accordance with claim 1, wherein at least two joint points are set at a common location in order to reproduce a human joint with at least two rotational degrees of freedom.

13. A method in accordance with claim 1, wherein the angles of rotation of at least two joint points are stored in a single-column vector and compared row by row with the angle of rotation preset value in the form of a single-column vector.

14. A method in accordance with claim 1, wherein if it is impossible to recognize a limb or a joint point or both a limb and a joint point in a next image, the angle of rotation of the initial image is taken over for the next image.

15. A recognition device for recognizing gestures of a human body, the device comprising:
a depth camera device; and
a control unit configured to:
generate a point cloud with the depth camera device at a first time as an initial image;
analyze the initial image to recognize limbs of a body;
set at least one joint point with a rotational degree of freedom defined by an angle of rotation in reference to at least one recognized limb;
generate a point cloud with the depth camera device at a second time, after the first time, as a next image;
analyze the next image with respect to the at least one recognized limb and the at least one joint point set from the initial image;
determine the angle of rotation of the at least one joint point in the next image;
compare the determined angle of rotation with an angle of rotation preset value; and
recognize a gesture in case of correlation of the determined angle of rotation with the angle of rotation preset value.

16. A recognition device in accordance with claim 15, wherein the control unit is further configured to:
generate further point clouds with the depth camera device at successive times, after the second time;
analyze the further images with respect to the at least one recognized limb and the at least one joint point set from the next image;
determine the angle of rotation of the at least one joint point in the further images;
compare the determined angle of rotation with an angle of rotation preset value; and
recognize a gesture in case of correlation of the determined angle of rotation with the angle of rotation preset value.

17. A recognition device in accordance with claim 15, wherein the angle of rotation preset value comprises a preset angle of rotation range, and a comparison is made to check whether the determined angle of rotation is within the angle of rotation range.

18. A recognition device in accordance with claim 15, wherein the control unit is further configured to generate the point cloud with the depth camera device at the first time as an initial image and analyze the initial image to recognize limbs of the body with a defined gesture of the limb.

19. A recognition device in accordance with claim 15, wherein the control unit is further configured to:
generate the point cloud with the depth camera device at the first time as an initial image;
analyze the initial image to recognize limbs of the body;
set at least one joint point with the rotational degree of freedom defined by an angle of rotation in reference to at least one recognized limb;
generate the point cloud with the depth camera device at the second time, after the first time, as the next image;
analyze the next image with respect to the at least one recognized limb and the at least one joint point set from the initial image;
determine the angle of rotation of the at least one joint point in the next image;
compare the determined angle of rotation with an angle of rotation preset value; and
recognize the gesture in case of correlation of the determined angle of rotation with the angle of rotation preset value for a plurality of joint points, wherein the joint points together form a limb model.

20. A recognition device in accordance with claim 15, wherein the control unit is further configured to recognize all points of the point cloud belonging to the at least one joint point during the analysis of the next image and assign a centroid of the points as a new joint point.
